(19) United States
(12) Patent Application Publication
(10) Pub. No.: US 2025/0132923 A1
(43) Pub. Date: Apr. 24, 2025

(54) MULTIPLE ELECTRONIC SIGNATURE PLATFORM

(71) Applicant: ADP, Inc., Roseland, NJ (US)

(72) Inventor: Roel Punzalan, Los Angelos, CA (US)

(73) Assignee: ADP, Inc., Roseland, NJ (US)

(21) Appl. No.: 18/491,526

(22) Filed: Oct. 20, 2023

(51) Int. Cl. H04L 9/32

(52) U.S. Cl. CPC H04L 9/3247

(57) ABSTRACT

A multiple electronic signature platform is provided. A system determines, based on a first model, a constraint to electronically sign an electronic document. The system identifies a plurality of candidate electronic signatures linked with an entity that satisfy the constraint. The system generates, based on a second model established for the entity, a ranking of the plurality of candidate electronic signatures that satisfy the constraint. The system provides, based on the ranking, an indication of one or more electronic signatures of the plurality of candidate electronic signatures. The system constructs, responsive to a selection of an electronic signature of the one or more electronic signatures, a modified electronic document with the electronic signature.

### TECHNICAL FIELD

This disclosure is directed to a platform to provide multiple electronic signatures.

### BACKGROUND

An electronic document can be executed or completed with an electronic signature. However, as there are an increasing number of types of documents, it can be challenging to efficiently execute an electronic document without introducing errors or delays in the execution process.

### SUMMARY

Aspects of technical solutions of this disclosure can be directed to a digital platform for saving and choosing from multiple electronic signatures. The platform can use or allow the multiple electronic signatures to be used to sign an electronic document. For example, due to the various types of electronic documents, use cases for electronic documents, or downstream processing being performed on electronic documents, it can be challenging to determine, identify, or select an electronic signature that is compatible with the electronic document or the downstream processing of the electronic documents. Selecting and applying an incompatible signature to an electronic document can result in erroneous downstream processing, which may cause electronic signature platforms to discard the executed electronic document and re-apply a different electronic signature, resulting in excess computer resource utilization, memory utilization, network bandwidth consumption, and latency or delay in the process of executing an electronic document and the downstream processing of the electronic document.

Systems and methods of this technology can provide a multiple electronic signature platform. The platform can store multiple electronic signatures to be applied to electronic documents via devices linked to a particular entity. When the platform receives a request or instruction to configure an electronic document for electronic signature, the platform can analyze the electronic document to identify a constraint. The platform can use the constraint to identify, determine, or select candidate electronic signatures that are compatible with the electronic document. Upon determining the candidate signatures that are compatible with the electronic document based on the constraint, the platform can rank the candidate electronic signatures. For example, the platform can rank the electronic signatures based on historical performance metrics associated with the candidate electronic signatures. The platform can provide a prompt or window with the ranked candidate electronic signatures. The platform can receive a select of one of the ranked candidate electronic signatures (e.g., the highest ranking candidate electronic signature), and then configure, construct, update, or modify the electronic document to include the selected electronic signature. Thus, by automatically detecting the constraint and using the constraint to identify compatible candidate signatures, and then ranking the candidate signatures based on historical performance or other factors, aspects of the technical solutions disclosed herein can reduce errors in execution of electronic documents, thereby reducing computer resource utilization, memory utilization, network bandwidth consumption, and latency or delay in the process of executing an electronic document and the downstream processing of the electronic document.

An aspect of this disclosure can be directed to a system. The system can include one or more processors, coupled with memory. The one or more processors can determine, based on a first model, a constraint to electronically sign an electronic document associated with an entity. The one or more processors can identify a plurality of candidate electronic signatures linked with the entity that satisfy the constraint. The one or more processors can generate, based on a second model established for the entity, a ranking of the plurality of candidate electronic signatures that satisfy the constraint. The one or more processors can display, based on the ranking, one or more electronic signatures of the plurality of candidate electronic signatures. The one or more processors can construct, responsive to a selection of an electronic signature of the one or more electronic signatures, a modified electronic document with the electronic signature.

To determine the constraint based on the first model, and in some implementations, the one or more processors can determine a type of the electronic document. The one or more processors can select, based on the type of the electronic document, the first model from a plurality of models. The first model can be trained with machine learning on training data related to constraints to electronically sign the type of the electronic document.

The constraint can include at least one of a geographic region or an authorization level. To identify the candidate electronic signatures linked with the entity that satisfy the constraint, the one or more processors can access a data repository that stores profiles linked to a plurality of electronic signatures established by the entity. The one or more processors can filter, based on the constraint, the profiles to identify the plurality of candidate electronic signatures.

To determine the ranking based on the second model, the one or more processors can identify the second model trained with machine learning on training data related to historical performance of the plurality of candidate electronic signatures. To generate the ranking based on the second model, and in some implementations, the one or more processors can identify profile data associated with the plurality of candidate electronic signatures. The one or more processors can input the profile data into the second model to generate the ranking

In some implementations, the one or more processors can provide, responsive to construction of the modified electronic document, a notification to a source of the electronic signature. The one or more processors can receive, responsive to the provision of the indication of the one or more electronic signatures based on the ranking, a selection of the electronic signature. The one or more processors can transmit a request for authorization to a source of the electronic signature. The one or more processors can construct the modified electronic document with the electronic signature responsive to receipt of the authorization.

The one or more processors can receive, responsive to the provision of the indication of the one or more electronic signatures based on the ranking, a selection of a second electronic signature. The one or more processors can transmit, based on the selection, a request for authorization to a source of the second electronic signature. The one or more processors can receive a bounce message in response to the transmission. The one or more processors can provide, for display responsive to the bounce message, an indication of the electronic signature of the plurality of candidate electronic signatures based on the ranking. In some implementations, the one or more processors can update, subsequent to the bounce message, a status of the second electronic signature to prevent the second electronic signature from inclusion in a subsequent plurality of candidate electronic signatures for the entity.

An aspect of this disclosure can be directed to a method. The method can be performed by one or more processors, coupled with memory. The method can include the one or more processors receiving, from a device of an entity, an instruction to electronically sign an electronic document. The method can include the one or more processors determining, based on a first model, a constraint to electronically sign the electronic document. The method can include the one or more processors identifying a plurality of candidate electronic signatures linked with the entity that satisfy the constraint. The method can include the one or more processors generating, based on a second model established for the entity, a ranking of the plurality of candidate electronic signatures that satisfy the constraint. The method can include the one or more processors providing, based on the ranking, an indication of one or more electronic signatures of the plurality of candidate electronic signatures. The method can include the one or more processors constructing, responsive to a selection of an electronic signature of the one or more electronic signatures, a modified electronic document with the electronic signature.

An aspect of this disclosure can be directed a non-transitory computer-readable medium that stores processor-executable instructions that, when executed by one or more processors, cause the one or more processors to receive, from a device of an entity, an instruction to electronically sign an electronic document. The instructions can further cause the one or more processors to determine, based on a first model, a constraint to electronically sign the electronic document. The instructions can further cause the one or more processors to identify a plurality of candidate electronic signatures linked with the entity that satisfy the constraint. The instructions can further cause the one or more processors to generate, based on a second model established for the entity, a ranking of the plurality of candidate electronic signatures that satisfy the constraint. The instructions can further cause the one or more processors to provide, based on the ranking, an indication of one or more electronic signatures of the plurality of candidate electronic signatures. The instructions can further cause the one or more processors to construct, responsive to a selection of an electronic signature of the one or more electronic signatures, a modified electronic document with the electronic signature.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative example of a system of a multiple electronic signature platform.

FIG. 2 is an illustrative example of a method of a multiple electronic signature platform.

FIG. 3 is an illustrative example of a graphical user interface provided by a multiple electronic signature platform.

FIG. 4 is an illustrative example of a graphical user interface provided by a multiple electronic signature platform.

FIGS. 5A-5C are illustrative examples of graphical user interfaces provided by a multiple electronic signature platform.

FIG. 6 is an illustrative example of a graphical user interface provided by a multiple electronic signature platform.

FIG. 7 is an illustrative example of a method of a multiple electronic signature platform.

FIG. 8 illustrates a block diagram of an example computing system for implementing the embodiments of the present solution, including, for example, the system depicted in FIG. 1, the methods depicted in FIG. 2 and FIG. 7, and the graphical user interfaces depicted in FIGS. 3-6.

### DETAILED DESCRIPTION

Aspects of technical solutions of this technology are directed to a platform for multiple electronic signatures. For example, due to the various types of electronic documents, use cases for electronic documents, or downstream processing being performed on electronic documents, it can be challenging to determine, identify, or select an electronic signature that is compatible with the electronic document or the downstream processing of the electronic documents.

For example, a large entity can operate in multiple geographic jurisdictions (e.g., states, countries, or continents). As large entities have an increasingly large number of electronic signers with various authorizations, permissions, or security credentials, and electronic documents can be established with various constraints, it can be challenging to efficiently and reliable identify a particular electronic signature that is compatible with a particular electronic document. For example, there may be multiple authorization forms (e.g., Power of Attorney or Reporting Agent Authorization) that may be executed to authorize an entity to perform actions in various jurisdictions on behalf of entities. Entities can have different users signing the electronic forms for different jurisdictions, or other criteria for signing electronic documents. Failure to identify a compatible electronic signature can result in erroneous downstream processing, which may cause electronic signature platforms to discard the executed electronic document and re-apply a different electronic signature, or rejection of the electronic document, resulting in excess computer resource utilization, memory utilization, network bandwidth consumption, and latency or delay in the process of executing an electronic document and the downstream processing of the electronic document.

Aspects of technical solutions of this disclosure can be directed to a digital platform for saving and choosing from multiple electronic signatures. The platform can store multiple electronic signatures to be applied to electronic documents via devices linked to a particular entity. For example, this technology can identify the electronic documents for an entity that are to be signed, and provide a notification to a client device associated with the entity. A user of the client device can use various techniques to apply an electronic signature to the electronic document. For example, the user can: 1) request an electronic signature from an authorized signer; 2) provide their own information to create an e-signature themself; or 3) download, sign, and upload a signature form. The platform can save the electronic signatures, and apply the electronic signatures to electronic documents.

When a user, via a client device, selects a user interface element to electronically sign a particular electronic document or form, the platform can provide a prompt (e.g., a pop-up window) that displays the saved electronic signatures and allows the user to select which one of the saved electronic signatures to apply to the form.

However, in order to reduce errors related to executing the electronic document with incompatible electronic signatures, the technology can analyze the electronic document to identify a constraint when the platform receives a request or instruction to configure an electronic document for electronic signature. The technology can use the constraint to identify, determine, or select candidate electronic signatures that are compatible with the electronic document. Upon determining the candidate signatures that are compatible with the electronic document based on the constraint, the platform can rank the candidate electronic signatures. For example, the platform can rank the electronic signatures based on historical performance metrics associated with the candidate electronic signatures. The platform can provide a prompt or window with the ranked candidate electronic signatures. The platform can receive a select of one of the ranked candidate electronic signatures (e.g., the highest ranking candidate electronic signature), and then configure, construct, update, or modify the electronic document to include the selected electronic signature. Thus, by automatically detecting the constraint and using the constraint to identify compatible candidate signatures, and then ranking the candidate signatures based on historical performance or other factors, aspects of the technical solutions disclosed herein can reduce errors in execution of electronic documents, thereby reducing computer resource utilization, memory utilization, network bandwidth consumption, and latency or delay in the process of executing an electronic document and the downstream processing of the electronic document.

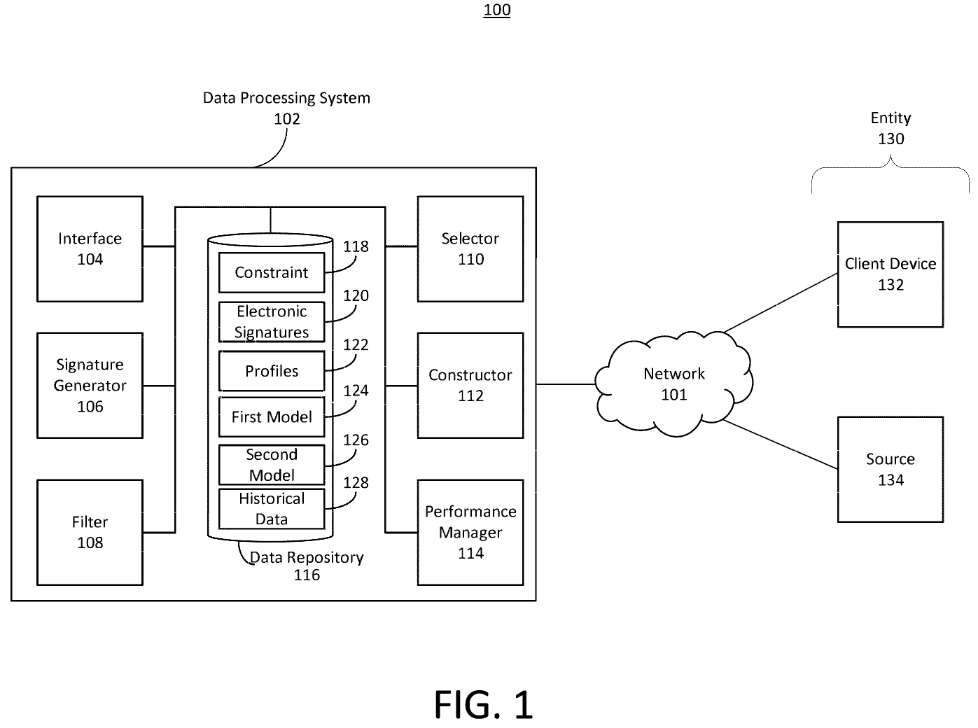

FIG. 1 is an illustrative example system 100 of a multiple electronic signature platform. The system 100 can include a data processing system 102. The data processing system 102 can include an interface 104 to communicate via network 101, or with one or more components of the data processing system 102. The data processing system 102 can include a signature generator 106 to establish or store signatures in the data repository 116. The data processing system 102 can include a filter 108 to identify candidate electronic signatures that satisfy a constraint of an electronic document. The data processing system 102 can include a selector 110 to select or rank candidate electronic signatures. The data processing system 102 can include a constructor 112 to apply an electronic signature to an electronic document. The data processing system 102 can include a performance manager 114 to identify historical performance of electronic signatures on electronic documents.

The interface 104, signature generator 106, filter 108, selector 110, constructor 112, or performance manager 114 can each communicate with data repository 116 or database. The data processing system 102 can include or otherwise access the data repository 116. The data repository 116 can include one or more data files, data structures, arrays, values or other information that facilitates operation of the data processing system 102. The data repository 116 can include one or more local or distributed databases, and can include a database management system. The data repository 116 can include, maintain, or store a constraint 118 for an electronic document. The constraint 118 can include a value, criteria, flag, instructions, pre-requisite, or other type of constraint. The constraint 118 can refer to or include a geographic constraint, a security constraint, an authorization constraint, or a role-based constraint, for example.

The data repository 116 can include, maintain, or store a electronic signatures 120. Electronic signature 120 (or e-signature) can refer to or include a digital representation of a handwritten signature. The e-signature can indicate the intent of the signer to approve or authenticate a document or transaction in electronic form. Types of electronic signatures 120 can include, for example, a digital signature, a typed signature, a drawn signature, or a scanned signature. A digital signature can use an encryption technology to create a unique identifier for each signer and ensure the integrity and authenticity of the signed document. The e-signature can include a typed or drawn signature that is input via an input device, such as a keyboard, mouse, touchpad, touchscreen, gestures, or voice input. The e-signature can include a scanned signature, in which a physical signature can be scanned or photographed and uploaded to the data processing system 102. The uploaded file can be in an image format, such as a JPEG, PNG or PDF.

The data repository 116 can include, maintain, or store a profile 122. The profile 122 can include information about an electronic signature 120 or a signer or source 134 of the electronic signature 120. The profile 122 can include or be linked with a corresponding electronic signature 120. For example, the profile 122 can include a security level of the signer or source 134 of the electronic signature, an authorization level, a role or title of the signer in an entity, a geographic location of the signer, a jurisdiction for which the signer is authorized to sign documents, availability of the signer of the electronic signature, or a status of the electronic signature or source 134 (e.g., employment status).

The data repository 116 can include, maintain, or store a first model 124 used to identify a constraint 118 in an electronic document. The first model 124 can be a machine learning model. For example, the first model 124 can be trained using machine learning and training data. The training data can include or be based on historical data 128. The training data can be related to constraints on electronically signing an electronic document. The training data can include, for example, performance of execution of electronic documents, profile information associated with electronic signatures, electronic documents, or metadata associated with electronic documents.

The data repository 116 can include, maintain, or store a second model 126 used to rank candidate electronic signatures. The second model 126 can be a machine learning model. For example, the second model 126 can be trained using machine learning and training data. The training data can be the same or different training data used to train the first model 124. The training data used to train the second model 126 can include or be based on historical data 128. The training data can include, for example, performance of execution of electronic documents, profile information associated with electronic signatures, electronic documents, or metadata associated with electronic documents.

In some cases, the first model 124 and the second model 126 can form a single model. In some cases, the first model 124 and the second model 126 can be separate models that are each trained, customized, or tuned to receive a respective input and provide a respective output.

The data processing system 102 can interface with, communicate with, or otherwise receive or provide information with one or more of a client device 132 or source 134 via a network 101. The data processing system 102, client device 132, or source 134 can each include at least one logic device such as a computing device having a processor to communicate via the network 101. The data processing system 102, client device 132, or source 134 can include at least one computation resource, server, processor or memory. For example, the data processing system 102 can include a plurality of computation resources or processors coupled with memory.

The network 101 can include computer networks such as the Internet, local, wide, metro, or other area networks, intranets, satellite networks, and other communication networks such as voice or data mobile telephone networks. The network 101 can include wired or wireless networks, connections, or communication channels. The network 101 can be used to transmit or receive information or commands to or from various components or sources. The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network.

The data processing system 102 can be part of or include a cloud computing environment. The data processing system 102 can be referred to as, or include, one or more processors coupled with memory. The data processing system 102 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous-one or more of the servers or machines can operate according to one or more type of operating system platform.

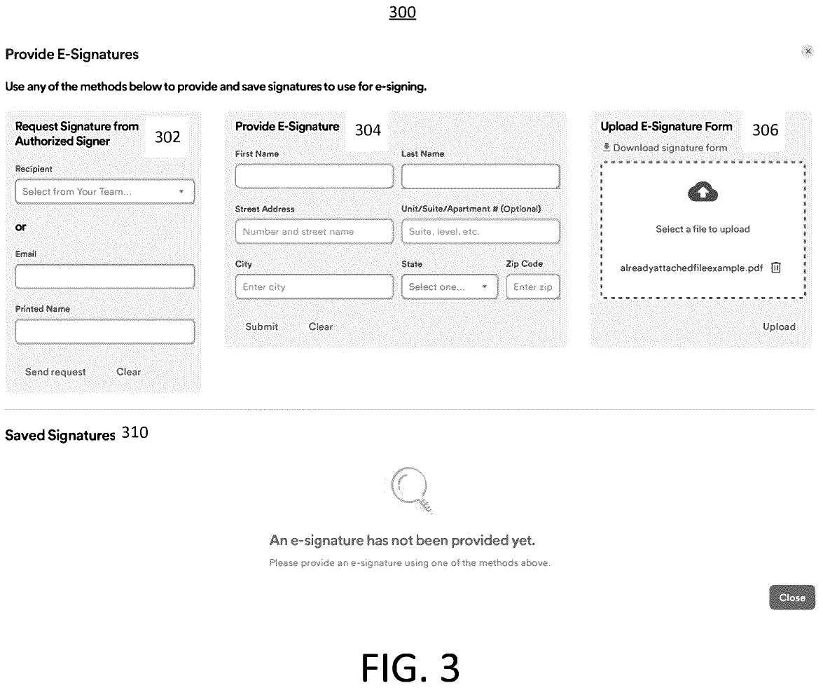

The data processing system 102 can include an interface 104 designed, constructed and operational to receive or transmit data via network 101 or between one or more components of the data processing system 102. The interface 104 can include a network interface or communication port. The interface 104 can include or provide a graphical user interface for display via a display device. The interface 104 can include, for example, a user interface operational to receive user input, and provide user output. The interface 104 can provide a graphical user interface, such as the graphical user interfaces depicted in FIGS. 3-7.

The interface 104 can receive electronic signatures 120 from one or more sources 134 or client device 132. The source 134 can refer to a source of an electronic signature, such as a signer. The source 134 can include a computing device or client device. The source 134 can include a device that receive, as input, a typed or signed electronic signature, or a photograph of a signature. The source 134 can be managed, controlled, or otherwise used by a signer of the electronic signature 120.

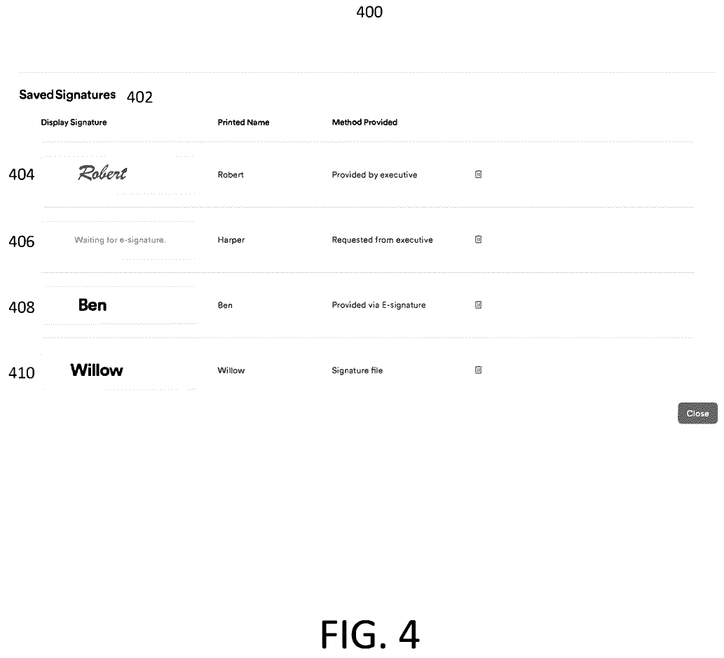

The data processing system 102 can include a signature generator 106 designed, constructed or operational to establish electronic signatures 120 in the data repository 120. The signature generator 106 can provide a graphical user interface to receive electronic signatures, such as the graphical user interface depicted in FIGS. 3-4. To establish or generate electronic signatures, the signature generator 106 can identify an entity 130. The entity 130 can include an organization, corporate entity, a company, or other structure. The entity 130 can include a unique identifier, name, or other identification. The electronic signatures 120 can be linked to an entity 130 and authorized to sign electronic documents for the entity 130. For example, to sign a power of attorney electronic document for the entity 130, the electronic signature 120 can be linked with the entity 130 and have an active employment status with the entity 130.

The signature generator 106 can provide a prompt for the electronic signature. The prompt can include a request for an electronic signature or other type of signature. The prompt can include a request for information, such as profile information that includes a name of a signer, or address of the signer (e.g., physical address or an electronic message or e-mail address). The profile information can include a geographic location or jurisdiction for which the signer is authorized to sign documents. The profile information can include an authority level of the signer, such low, medium, or high. The authority level can indicate a size or amount of a transaction for which the signer is authorized to sign (e.g., authorized to sign for up to a $100 transaction, $1000 transaction, $100,000 transaction, $250,000 transaction, $500,000 transaction, $1,000,000 transaction, $10,000,000 transaction, or other amount). The profile information can include a security level of the signer, such as low, medium or high. The security level can refer to a confidentiality level associated with the electronic document, such as privileged, confidential, company secret, or trade secret. The profile information can include a title of the signer, such as chief executive officer, general counsel, manager, secretary, or other title.

The signature generator 106 can provide a prompt that requests the types of electronic documents for which the electronic signature can be applied, such as tax documents, powers of attorney, reporting agent authorization, or purchase orders, for example.

The signature generator 106 can provide a prompt for a type of signature. The signature generator 106 can receive an indication for a type of signature. A type of signature can include a digital signature, typed e-signature, drawn e-signature, or a printed, scanned and uploaded signature.

For example, a client device 132 of the entity 130 can interact with the data processing system 102 or signature generator 106 to establish the profile 122 for the electronic signature 120. The client device 132 can provide an address for the source of the 134 of the electronic signature 120. The client device 132 can instruct the data processing system 102 to interact with the source 134 to obtain the electronic signature 120 from the source 134. For example, a first user can use the client device 132 to establish a profile for an electronic signature of a second user, where the second user corresponds to the source 134 (e.g., a source device associated with the signer).

The data processing system 102 can transmit a request to the source 134 to input an digital signature or other electronic signature. The data processing system 102 can transmit a request to the source 134 to download, print, sign, and upload a signature form to the data processing system 102. In some cases, the client device 132 can instruct the signature generator 106 to request that the source 134 update the profile 122 or complete one or more field or portion of the profile 122, or confirm one or more aspects of the profile 122.

The signature generator 106 can receive the electronic signature 120 from the source 134, and store the electronic signature 120 in data repository 116. The signature generator 106 can link or otherwise map or associate the electronic signature 120 with the corresponding profile 122. The data processing system 102 can store the electronic signature in an encrypted manner. The data processing system 102 can include a timestamp for when the electronic signature 120 was generated. In some cases, the signature 120 can set an expiration date or expiration time interval for the electronic signature 120. The expiration time interval can be 24 hours, 48 hours, 72 hours, 1 week, 30 days, 1 month, 60 days, 90 days, 6 months, 1 year, or other time interval. The expiration time interval can be set or established by the client device 132, the source 134, or a security policy of the entity 130. The signature generator 106 can reset or refresh the electronic signature prior to expiration by sending an refresh request to the source 134 or client device 132. Responsive to authorization or approval to reset the expiration interval or otherwise keep the electronic signature active, the signature generator 106 can reset the expiration interval.

The data processing system 102 can receive an instruction to electronically sign an electronic document. The data processing system 102 can receive the instruction from the client device 132, which can be administered or otherwise under the control of the entity 130. The data processing system 102 can receive the instruction via the interface 104. The data processing system 102 can provide a graphical user interface for render or display on the client device 132, which can be used to provide the instruction to electronically sign the electronic document.

The data processing system 102 can include a filter 108 designed, constructed or operational to determine a constraint to electronically sign the electronic document. The filter 108 can use a first model 124 to determine the constraint. For example, to determine the constraint, the filter 108 can analyze, parse, or otherwise process the electronic document. In some cases, the filter 108 can receive the constraint 118, or indication of the constraint 118 (e.g., a constraint identifier, symbol, text, or metadata) from the client device 132. For example, the client device 132 can provide the constraint 118 when providing the instruction to electronically sign the electronic document. The constraint can refer to a criteria or factor that is to be satisfied by the electronic signature in order for the electronic signature to be compatible with the electronic document.

In some cases, to determine the constraint 118, the filter 118 can identify the first model 124 to use. The filter 108 can select the first model from a set of models. For example, the data processing system 102, or data repository 116, can store, maintain or manage multiple models or multiple first models 124. The filter 108 can select a first model 124 that is configured, trained, or otherwise tuned to process a type of electronic document.

To do so, the filter can determine the type of the electronic document for which the instruction to electronically sign is received. The data processing system 102 can receive the indication of the type of electronic document from the client device 132, or the type of electronic document can be indicated in a filename of the electronic document or metadata associated with the electronic document.

Upon determining the type of the electronic document, the filter 108 can select a first model 124 that is configured for the type of the electronic document. For example, the data repository 116 can store multiple models, and the filter 108 can select a first model 124 from the multiple models that matches the type of the electronic document.

The first model 124 can be a machine learning model. The first model 124 can be trained with machine learning on training data related to constraints to electronically sign the type of the electronic document. For example, the training data can include historical data 128. The training data can include a training set of electronic documents and labels. The training data can include text information.

To determine the constraint in the electronic document, the first model 124 can be trained using one or more machine learning techniques. For example, the machine learning technique can include a text classification technique, such as a Naïve Bayes classifier, logistic regression, or a support vector machine. The Naïve Bayes classifier can be configured to classify the text to determine a constraint of the document. The logistic regression can be used for binary or multi-class text classification. The support vector machine can be configured to text classification.

In some cases, the first model 124 can be trained with a natural language processing model, such as a recurrent neural network or a convolution neural network. The recurrent neural network can be used to model sequential data in the text of the document to determine the context of the document, from which the constraint of the document can be inferred. The convolution neural network can be used to classify the document based on text and images in the document.

The filter 108 can be configured with, or to utilize, a word embedding models that can convert words or phrases in the electronic document into numerical vectors, which can be used as input into the first model 124.

In some cases, the first model 124 can be a rule-based model configured with domain-specific rules about the electronic document, which can determine the constraint associated with the document. For example, the rule based model can identify a geographic location or area stated in the electronic document, and then determine that the constraint for the electronic signature for the document is a geographic region. In another example, the filter 108 can identify a title (e.g., chief executive officer, treasurer, general counsel, or secretary) in the signature block in the electronic document, and then determine that the constraint for the electronic signature is an authorization level.

The filter 108 can identify additional constraints using the first model 108 that are based on, for example, amount of a monetary transaction, duration or term of the contract or electronic document, a number or count of parties that are signatories to the electronic document, a name or type of the other party in the electronic document (e.g., the party with which the entity 130 is transacting). For example, if the other party is a financial institution or financial services provider, then the constraint for the electronic signature authorization level or role can be a treasurer. In another example, if the other party is a legal services provider, then the authorization level of the electronic signature can be in-house counsel.

The filter 108, upon identifying the constraint, can identify one or more candidate electronic signatures that are linked with the entity 130 and that satisfy the constraint. The filter 108 can determine whether the electronic signature is compatible with the electronic document based on the constraint 118 of the electronic document. The filter 108, to identify the candidate electronic signatures, can query the electronic signatures 120 data structure or the profile 122 data structure. The filter 108 can perform a lookup in the electronic signatures 120 data structure or the profiles 122 data structure to identify the candidate electronic signatures that satisfy the constraint or are compatible with the electronic document. For example, the profile 122 information can include information that facilitate identifying a match between the profile 122 and the constraint, and the matching profile 122 can include a link, map, or identifier of the corresponding electronic signature 120.

For example, if the constraint in the electronic document is geographic region, then the filter 108 can identify electronic signatures 120 established for the entity 130 that are also authorized for application in the same geographic region. In another example, if the constraint is authorization level (e.g., treasurer), then the filter 108 can identify electronic signatures associated with a profile parameter that indicates the treasurer title. In some cases, the filter 108 can identify multiple constraints in the electronic document, and then identify the electronic signatures that satisfy the multiple constraints as the candidate electronic signatures.

If the filter 108 does not identify any electronic signatures that satisfy the constraint, then the data processing system 102 can provide a notification, prompt, or error message stating that there are no candidate electronic signatures. The client device 132 can then instruct the data processing system 102 to identify a new signer or source 134 and establish a new electronic signature 120 and profile 122 for the new source 134.

The data processing system 102 can include a selector 110 designed, constructed and operational to generate a ranking of the plurality of candidate electronic signatures that satisfy the constraint. The selector 110 can generate the ranking based on a second model established for the entity. The selector 110 can provide, for display, an indication of one or more electronic signatures based on the ranking. For example, the filter 108 can identify multiple candidate electronic signatures that satisfy the constraint, and provide the candidate electronic signatures to the selector 110. Since only one of the candidate signatures may be required for application to the electronic document, the selector 110 can recommend or suggest a top ranking candidate electronic signature.

To do so, the selector can use a second model 126 to rank the candidate electronic signatures. The data processing system 102, by ranking the candidate electronic signatures that satisfy the constraint, as opposed to ranking all available electronic signatures 120 in the data repository 116 that are associated with an entity 130, can reduce computer resource utilization by the selector 110.

The selector 110 can determine the ranking by inputting the candidate electronic signatures that satisfy the constraint into the second model 126. The second model 126 can be a machine learning model trained with training data related to historical performance of the plurality of candidate electronic signatures. The historical performance can be based on historical data 128. The historical performance data can be collected, monitored, tracked or otherwise obtained by the performance manager 114. The historical performance data can be based which candidate signatures were selected by client devices 132 for application on electronic documents. For example, if the electronic document is related to a tax service, and client devices 132 historically were more likely to select electronic signatures of a treasurer, then even though multiple candidate electronic signatures may satisfy the constraint for the document, the selector 110 can score or rank the electronic signature of the treasurer as the highest or top scoring candidate electronic signature.

Thus, the second model 126 can be trained on historical performance data, constraints, and electronic documents to determine a score or ranking of a candidate electronic signature to suggest the candidate electronic signature that is most likely to be selected and applied by the client device 132. For example, the selector 110 can identify profile data (e.g., treasurer title or geographic region) associated with the plurality of candidate electronic signatures, and input the profile data into the second model 126 to generate the ranking.

The second model 126 can be trained with one or more machine learning techniques. For example, the second model 126 can be trained with a linear regression or logistic regression. The linear regression model can generate or predict a numerical score or rank for each candidate electronic signature, and then sort the candidate electronic signatures based on the score. The machine learning model can be a binary model, such as a logistic regression, which can be configured to rank the candidate electronic signature as relevant or not relevant to the electronic document or constraint. The second model 126 can be based on a pairwise ranking model, such as a neural network based model that learns to rank by comparing pairs of items.

The selector 110 can score each of the candidate electronic signatures based on factors associated with the profiles of the candidate electronic signatures. The selector 110 can weight parameters or factors listed in the profiles. The selector 110 can apply a load balancing technique such that the same electronic signature is not uniformly applied on all documents when there are other viable candidate electronic signatures that satisfy the constraint of the electronic signature. By applying the load balancing function (e.g., a round robin or a hash table), the selector 110 can prevent overloading a particular source 134 with requests for approval or authorization, or notifications of applications of the electronic signature provided by the source 134, thereby reducing the computing resource utilization of the source associated with generating such notifications, prompts, or requests for approval.

In some cases, the selector 110 can rank electronic signatures based on the time sensitive nature of the electronic document, and the responsiveness of the source 134 of the electronic signature to approve application of an electronic signature based on historical performance. The selector 110 can rank electronic signatures based on an importance of the electronic document (e.g., dollar amount of the transaction, or opposing party type), and the profile information.

The data processing system 102 can include a constructor 112 designed, constructed and operational to construct a modified electronic document with the electronic signature. The constructor 112 can construct the modified electronic document responsive to a selection of the electronic signature of the one or more candidate electronic signatures. Constructing the modified electronic document can refer to or include applying the electronic signature to the electronic document. For example, the constructor 112 can apply the digital signature, typed signature, drawn signature, or the uploaded scanned electronic signature to a signature block or other location in the electronic document.

The constructor 112 can provide a notification to a source 134 of the electronic signature that is to be applied to the electronic document. The constructor 112 can provide the notification responsive to construction of the modified electronic document, or prior to the construction. For example, if the profile 122 of the electronic signature or metadata of the electronic document authorizes the client device 132 to apply the electronic signature to the electronic document without first obtaining permission for the application, then the constructor 112 can automatically apply the electronic signature without transmitting a request for authorization or approval to the source 134.

In some cases, the constructor 112 can transmit a request for authorization or approval to the source 134 prior to applying the selected electronic signature. For example, the constructor 112 can receive, responsive to the provision of the indication of the one or more electronic signatures based on the ranking, a selection of the electronic signature. The constructor 112 can transmit a request for authorization to the source 134 of the electronic signature. The request can include an electronic message, electronic mail, hyperlink, text message, prompt via a graphical user interface, or multi-factor authentication technique. The source 134 can provide an approval to the request by selecting hyperlink, interacting with a graphical user interface element (e.g., a button), or inputting a password or authorization code. In some cases, the authorization can be in the form of biometric credentials, such as fingerprint, voice signature, facial identification, or retinal signature. The constructor 112 can construct the modified electronic document with the electronic signature responsive to receipt of the authorization.

The constructor 112 can apply the electronic signature to execute the electronic document. The constructor 112 can be configured to perform additional processing on the executed electronic document (e.g., the modified electronic document containing the electronic signature), or the constructor 112 can transmit the electronic document to the client device 132 or other device or component for further processing or utilization. The data processing system 102 can store the modified electronic document in the data repository 116.

The data processing system 102 can include a performance manager 114 designed, constructed and operational to monitor or track the performance of electronic signatures on electronic documents, or sources 134 that facilitate the application of the electronic signature. Performance of an electronic signature can include, for example, the number of times or frequency with which the electronic signature is selected by the filter 108 to be a candidate electronic signature that satisfies a constraint. Performance of an electronic signature can include, for example, the number of times or frequency with which the candidate electronic signature is ranked highly or as the highest ranking candidate electronic signature by the selector 110. The performance of the electronic signature can include the number of times, of frequency with which, the electronic signature is actually selected for application to the electronic document.

Performance metrics can include statistic metrics, ratio, or likelihoods. For example, a performance metric can indicate the frequency with which an electronic signature is selected for application on an electronic document when the electronic signature is the highest ranking candidate electronic signature. A performance metric can be for a specific constraint or type of electronic document. For example, the frequency an electronic signature is the highest ranking candidate electronic signature in a particular geographic region.

Performance metrics can include responsiveness of the source 134, or the number of times or frequency with which a source 134 authorizes a request to apply the electronic signature provided by the source. Performance metrics associated with the source 134 can be specific to a constraint.

The performance metrics performance data detected, monitors, or otherwise tracked by the performance manager 114 can be stored in the historical data 128 data structure. One or more component of the data processing system 102 can utilize the historical data 128. For example, the filter 108 or selector 110 can utilize the historical data 128 to train the first model 124 or the second model 126. The signature generator 106 can update a profile 122 based on data detected by the performance manager 114.

The performance manager 114 can determine a status of the source 134. For example, the data processing system 102 can receive a selection of an electronic signature to apply to an electronic document. Prior to application of the electronic signature, the data processing system 102 can transmit a request for authorization to the source 134 of the electronic signature. The data processing system 102 can transmit the request as an electronic mail (e-mail) to the address of the source 134 listed in the profile 122. The data processing system 102 (e.g., via performance manager 114) can receive a bounce message in response to the transmission. The data processing system 102 can be separate from the entity 130 and not contain human resource or other employment status of the source 134. That is, the employment status of the source 134 as stored in the profile 122 may not be synchronized or updated based on the actual employment status of the source 134 as maintained by the entity 130 in a local records system. Thus, the data processing system 102 may erroneously identify the electronic signature as a viable candidate, highly rank the electronic signature, suggest the electronic signature to the client device, and receive a selection from the client device 132 to apply the electronic signature.

Prior to application, the data processing system 102 can transmit the request for authorization via e-mail address of the source 134 listed in the profile 122. Instead of receiving an approval or rejection, the data processing system 102 can receive a bounce message. The bounce message can include an error message or error notification that indicates that the e-mail address of the source 134 is no longer active, inactive, or disabled. The bounce message can be from an e-mail server. The performance manager 114 can receive, intercept or otherwise identify the bounce message for the e-mail address, and determine that the employment status of the source 134 has changed to inactive. The data processing system 102 can update the profile 122 to indicate an inactive employment status to prevent the filter 108 from identifying the electronic signature as a candidate electronic signature for an electronic document for the entity 130 in the future. The data processing system 102 can update, subsequent to the bounce message, a status of the second electronic signature to prevent the second electronic signature from inclusion in a subsequent plurality of candidate electronic signatures for the entity. The data processing system 102 can then select a second highest ranking electronic signature for the electronic document.

In some cases, the performance manager 114 can receive an automatic reply e-mail message. An automatic reply, unlike a bounce message, may indicate that the source 134 is still employed at the entity, but currently unavailable for a duration. The performance manager 114 can parse the automatic reply, determine the duration of unavailability, and then update the profile 122 for the electronic signature to prevent the filter 108 from selecting the electronic signature as a candidate electronic signature for the duration. In some cases, the filter 108 can still select the electronic signature as a candidate, but the selector 110 can apply a lower ranking or score to the candidate electronic signature during the duration the source 134 is unavailable as determined by the performance manager 114. Thus, if there are no other viable candidate electronic signatures that satisfy the constraint of the electronic document, then the selector 110 can suggest the electronic signature even though the source 134 may be currently unavailable because the source 134 can authorize the signature upon becoming available after the duration.

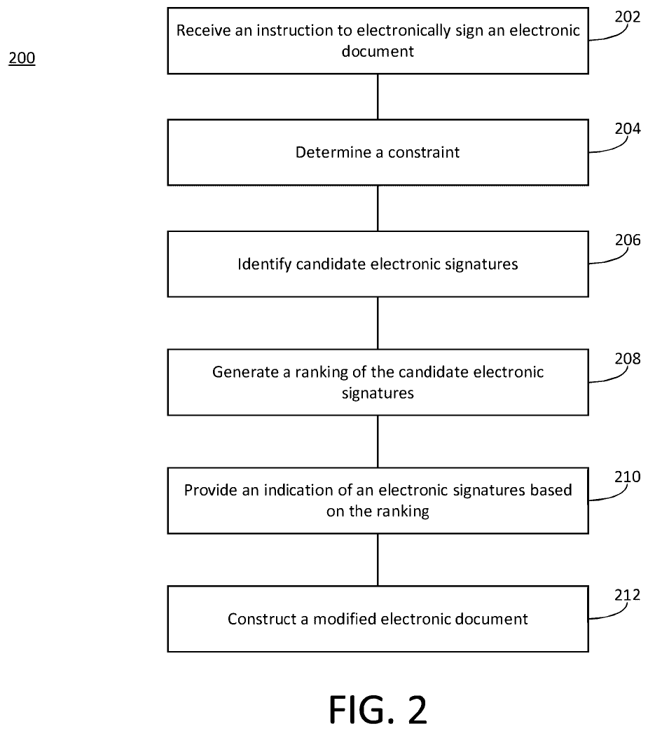

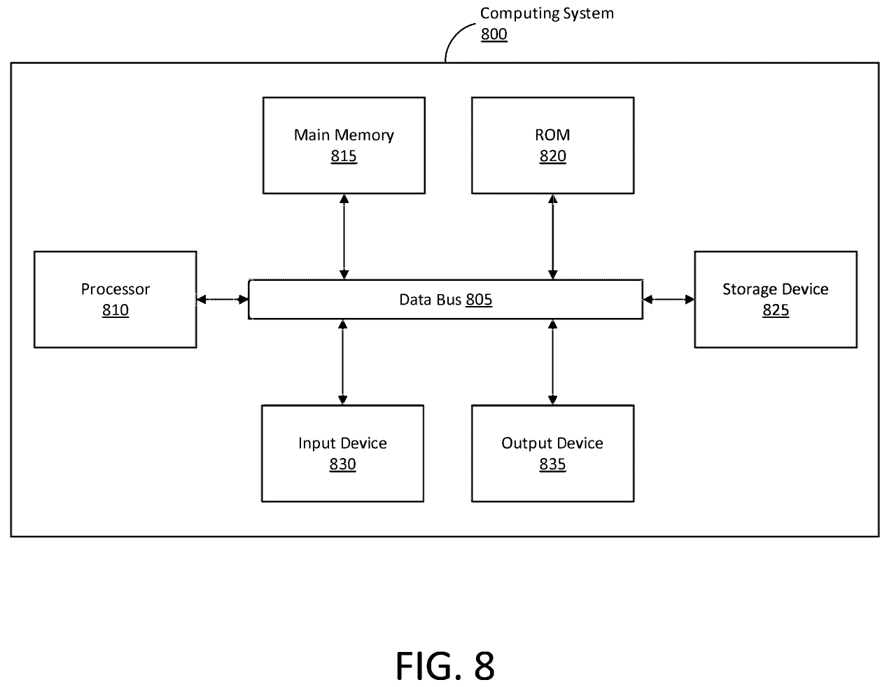

FIG. 2 is an illustrative example of a method 200 of applying electronic signatures via a multiple electronic signature platform. The method 200 can be performed by one or more processors. The method 200 can be performed by one or more system or component depicted in FIG. 1 or FIG. 8, including, for example, a data processing system. At ACT 202, the data processing system can receive an instruction to electronically sign an electronic document. The data processing system can receive the instruction from a client device. The data processing system can receive the instruction from a client device or user that is different from the device that is the source of the electronic signature or the signer. For example, the data processing system can receive the instruction from a first user to apply a signature of a different user. The data processing system can receive the instruction from a client device that is associated with or linked to an entity. The source of the signature or signer can also be linked or otherwise associated with the same entity.

The instruction can include identification or credential information associated with the client device or the entity to which the client device is associated. In some cases, the client device can perform a handshaking process to authenticate with the data processing system prior to providing the instruction to have an electronic document electronically signed.

At ACT 204, the data processing system can determine a constraint. The data processing system can determine a constraint to electronically sign the electronic document. The constraint can refer to a criteria or factor that is to be satisfied by the electronic signature in order for the electronic signature to be compatible with the electronic document. The data processing system can determine the constraint using a first model. The first model can include a machine learning model or a rules-based model. The data processing system can parse or otherwise process the electronic document using the model to determine a constraint of the electronic document, such as a geographic-based constraint or an authorization level.

At ACT 206, the data processing system can identify candidate electronic signature. The candidate signatures can refer to electronic signatures that are compatible with the electronic document or otherwise satisfy the one or more constraints of the electronic document. The candidate electronic signatures can be associated with the same entity that provided the electronic document or instruction to electronically sign the electronic document, for example. The data processing system can perform a lookup, apply a filter, or otherwise query a data repository to identify the candidate electronic signatures that satisfy the constraint or are otherwise compatible with the electronic document.

At ACT 208, the data processing system can generate a ranking of the candidate electronic signatures. The data processing system can score each of the candidate electronic signatures using a second model, and then rank the candidate electronic signatures based on the score. For example, in the event there are multiple electronic signatures, the data processing system can suggest a predetermined number of top ranking candidate electronic signatures to suggest, recommend, or display via a graphical user interface to the client device. The data processing system can score or rank the candidate electronic signatures based on historical performance metrics associated with executed electronic documents that contained the candidate electronic signatures, or performance information associated with selecting the candidate electronic signatures by client devices, or performance information associated with interactions with the sources of the electronic signatures.

At ACT 210, the data processing system can provide an indication of an electronic signature based on the ranking. The data processing system can sort or order the electronic signatures based on the ranking, such that a highest ranked or highest scoring electronic signature is listed most prominently in a graphical user interface. In some cases, the data processing system can suggest only the top ranking candidate electronic signature, or a predetermined number of the top ranking signatures (e.g., 2, 3, 4, 5 or other number depending on available space in a graphical user interface element or window).

At ACT 212, the data processing system can construct, responsive to a selection of an electronic signature of the one or more electronic signatures, a modified electronic document with the electronic signature. The data processing system can provide a notification to the source that the signature was applied, or request authorization from the source prior to application of the signature. If the data processing system request authorization from the source prior to execution of the electronic document, the data processing system can wait for the authorization prior to application of the signature. If the request to apply the signature is rejected by the source, then the data processing system can automatically suggest the next highest ranking electronic signature to the client device. The data processing system can, in some cases, automatically request authorization from the second source of the second signature.

FIG. 3 is an illustrative example of a graphical user interface (“GUI”) provided by a multiple electronic signature platform. The GUI 300 can be provided by one or more system or component depicted in FIG. 1, including, for example, a data processing system via an interface. The GUI 300 can be rendered or presented on a display device, such as a display device communicatively coupled with the data processing system or a client device.

The data processing system can provide the GUI to facilitate generating or establishing signatures. For example, the signature generator of the data processing system can provide the GUI 300. The GUI 300 can provide text boxes, elements, prompts, or instructions that facilitate generating electronic signatures or profiles for electronic signatures. The GUI 300 can provide different techniques, methods, or approaches to obtaining electronic signatures or different types of electronic signatures.

For example, the data processing system can request the signature from the authorized signature via GUI element 302. To do so, the data processing system can provide, via GUI element 302, an expandable window element or dropdown box with recipient for the request. The recipients of the request can be potential signers or sources of the electronic signature. The GUI element 302 can provide an option to input an e-mail address for the recipient, and the printed name of the recipient.

In GUI element 304, the data processing system can provide input text boxes to collect profile information for the electronic signature, such as a first name and last name of the source, and physical street address of the source. In GUI element 306, the data processing system can allow the source to download a signature form, print the signature form, physically wet sign the signature form, and then upload the signature form to the data processing system for storage in the data repository. In GUI element 310, the data processing system can provide an indication or list of the saved electronic signature, which, in the example depicted in FIG. 3, indicates that there are currently no saved signatures.

FIG. 4 is an illustrative example of a graphical user interface provided by a multiple electronic signature platform. The GUI 400 can be provided by one or more system or component depicted in FIG. 1, including, for example, a data processing system via an interface. The GUI 400 can be rendered or presented on a display device, such as a display device communicatively coupled with the data processing system or a client device. The GUI 400 can include one or more aspect of GUI 300 depicted in FIG. 3, including, for example, the saved signatures GUI element 310.

As depicted in FIG. 4, the saved signatures element 402 can include a list of one or more saved electronic signatures. The electronic signatures 404, 406, 408, and 410 can be provided using one or more methods via GUI 300, including, for example, provided by the source, requested from the source, provided via electronic signature, or uploaded via a signature file. The GUI 400 can indicate the status of the electronic signature, such as electronic signatures 404, 408 and 410 have each been received, whereas electronic signature 406 is still pending or not yet received as indicated by the “waiting for e-signature” status. Thus, the GUI 400 can display each of the saved electronic signatures or status of obtaining the electronic signature, the name of the source of the signature, and the method by which the electronic signature was provided or is being provided to the data processing system.

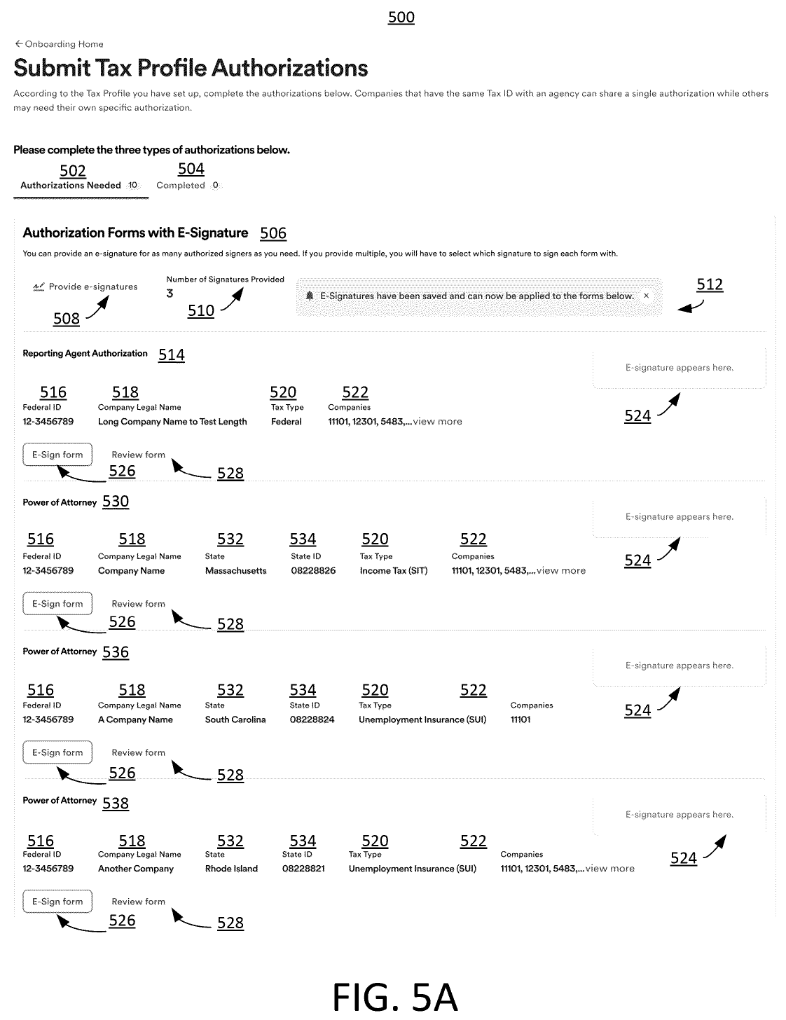

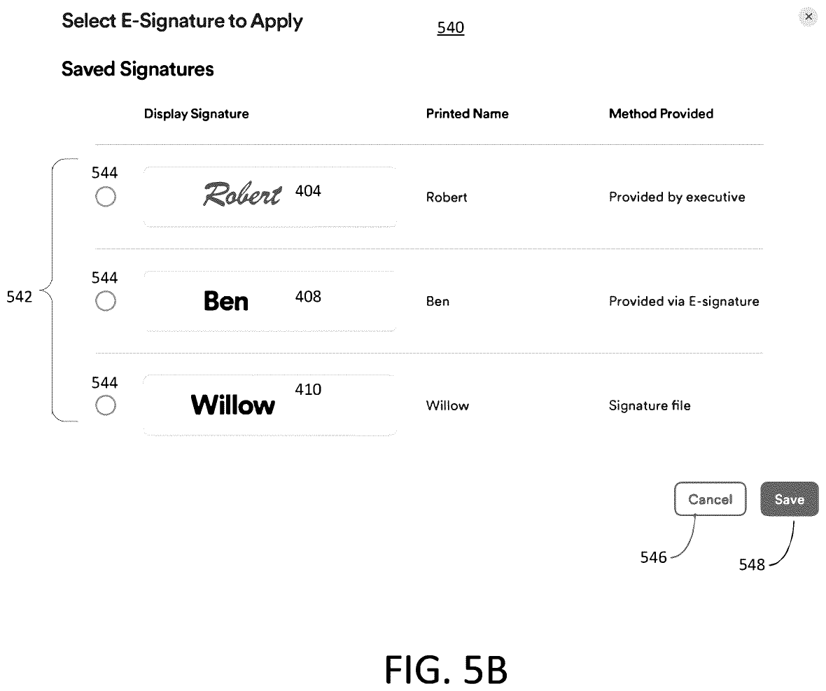

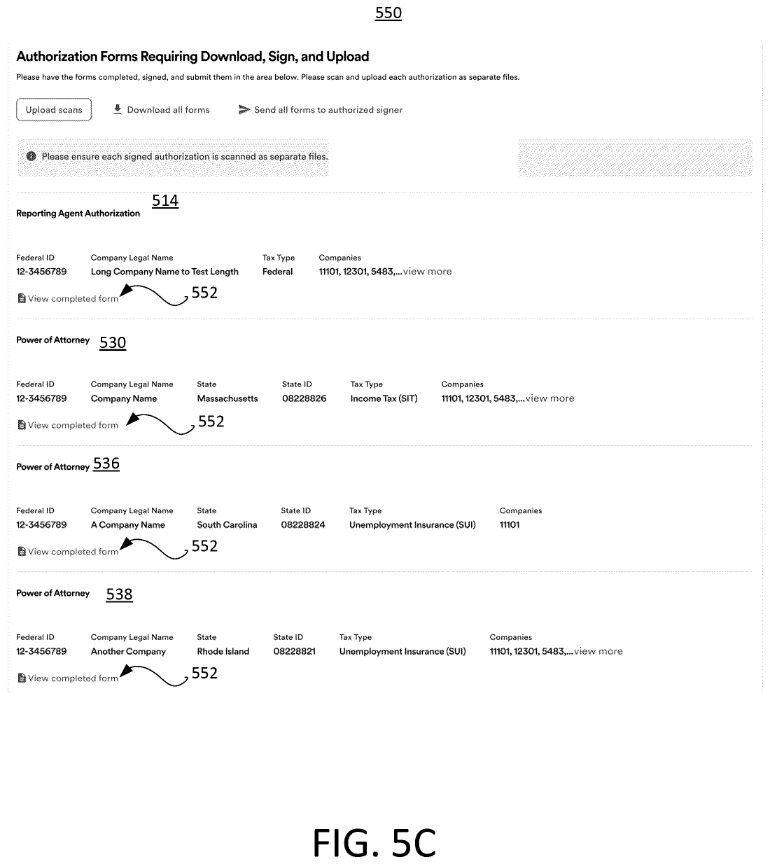

FIGS. 5A-5C are illustrative examples of graphical user interfaces provided by a multiple electronic signature platform. The GUI 500 can be provided by one or more system or component depicted in FIG. 1, including, for example, a data processing system via an interface. The GUI 500 can be rendered or presented on a display device, such as a display device communicatively coupled with the data processing system or a client device.

The data processing system 102 can provide GUI 500 to allow a client device 132 to facilitate electronically signing an electronic document. Using GUI 500, the data processing system 102 can apply one or more electronic signatures to one or more electronic documents. As depicted in example GUI 500, the electronic documents to be electronically signed can include tax profile authorization forms. For example, the data processing system 102 can determine that number of authorizations that are needed and provide a notification or indication 502 of the number of authorization that are needed (e.g., 10). The data processing system 102 can determine how many authorizations have been completed, and provide a notification or indication 504 of the number of authorizations that have been completed (e.g., 0).

The GUI 500 can include a section 506 that provides information about the authorization forms with e-signatures. The section 506 can include an interactive graphical user element to provide an e-signature 508. The data processing system 102 can detect a selection of the provide an e-signature 508 interactive element, and invoke GUI 300 depicted in FIG. 3 to obtain e-signatures, for example. The data processing system 102 can indicate the number of e-signatures that are provided 510 (e.g., three e-signatures provided). The three e-signatures may have been provided via GUI 300, for example. The data processing system 102 can provide an notification 512 of the status of the e-signatures, such as the number of e-signatures that have been provided and that the provided e-signatures are ready for application to an electronic document.

The GUI 500 can include sections for each electronic document. For example, the GUI 500 can provide a first section for a first electronic document 514, a second section for a second electronic document 530, a third section for a third electronic document 536, and a fourth section for a fourth electronic document 538. In each section, the data processing system 102 can provide, via GUI 500, information about the respective electronic documents 514, 530, 536 and 538. The data processing system 102 can determine the information via one or more component of the data processing system 102 depicted in FIG. 1.

The data processing system 102 can determine constraints or other attributes for the first electronic document 514. For example, a constraint or an attribute of the first electronic document 514 can be the type of the electronic document. The data processing system 102 can determine that the type of the electronic document is Reporting Agent Authorization. The data processing system 102 can display the type of the electronic document at 514. The data processing system 102 can determine or identify additional constraints or attribute of the electronic document, and display them as follows: federal ID 516, company legal name 518, tax type 520, or companies 522. The data processing system 102 can parse or otherwise process the first electronic document 514 or related metadata to determine values for the constraints or attributes of the first electronic document 514. The constraint-value or attribute-value pairs can include, for example, [federal ID; 12-3456789], [company legal name; Long company name], [tax type; federal], or [companies; 11101, 12301]. The data processing system 102 can construct data structures for the constraint-value or attribute-value pairs for storage in data repository.

The data processing system 102 can provide, via GUI 500, an interactive element or button 528 to review the electronic document. The data processing system 102 can provide, via GUI 500, an interactive element or button 526 to electronically sign the electronic document. A user can select, via an input device, the button 526 to instruct the data processing system 102 to apply an electronic signature to the electronic document. The data processing system 102 can provide an indication 524 of the status of the application of the electronic signature, which can display a representation of the electronic signature that is applied (e.g., a signature display 404, 406, 408 or 410).

The data processing system 102 can display, via GUI 500, a section to electronically sign a second electronic document 530. The GUI 500 can display the type of the second electronic document, such as Power of Attorney. The data processing system 102 can determine or identify additional constraints or attributes of the second electronic document, and display them as follows: federal ID 516, company legal name 518, state 532, state ID 534, tax type 520, or companies 522. The data processing system 102 can parse or otherwise process the second electronic document 530 or related metadata to determine values for the constraints or attributes of the second electronic document 530. The constraint-value or attribute-value pairs can include, for example, [federal ID; 12-3456789], [company legal name; Company Name], [state; Massachusetts], [state ID; 08228226], [tax type; income tax], or [companies; 11101, 12301].

The data processing system 102 can display, via GUI 500, a section to electronically sign a third electronic document 536. The GUI 500 can display the type of the third electronic document, such as Power of Attorney. The type of the third electronic document can be a same type as the second electronic document, but with different values for the constraints or attributes. In some cases, an electronic document of a same type can include different constraints or attributes. The data processing system 102 can determine or identify the constraints or attributes of the electronic document, and display them as follows: federal ID 516, company legal name 518, state 532, state ID 534, tax type 520, or companies 522. The data processing system 102 can parse or otherwise process the third electronic document 536 or related metadata to determine values for the constraints or attributes of the third electronic document 536. The constraint-value or attribute-value pairs can include, for example. [federal ID; 12-3456789], [company legal name; A Company Name], [state; South Carolina]. [state ID; 08228824], [tax type; unemployment insurance (SUI)], or [companies; 11101].

The data processing system 102 can display, via GUI 500, a section to electronically sign a fourth electronic document 538. The GUI 500 can display the type of the fourth electronic document, such as Power of Attorney. The type of the third electronic document can be a same type as the second electronic document, but with different values for the constraints or attributes. In some cases, an electronic document of a same type can include different constraints or attributes. The data processing system 102 can determine or identify the constraints or attributes of the electronic document, and display them as follows: federal ID 516, company legal name 518, state 532, state ID 534, tax type 520, or companies 522. The data processing system 102 can parse or otherwise process the fourth electronic document 538 or related metadata to determine values for the constraints or attributes of the fourth electronic document 538. The constraint-value or attribute-value pairs can include, for example, [federal ID; 12-3456789], [company legal name; Another Company Name], [state; Rhode Island]. [state ID; 08228821], [tax type; unemployment insurance (SUI)], or [companies; 11101, 12301].

Each of the electronic documents 514, 530, 536 and 538 can be electronically signed by selecting the respective e-sign button 526. Upon selecting the e-sign button 526 for an electronic document, the data processing system 102 can identify candidate electronic signatures, rank the candidate electronic signatures, and provide a suggestion or recommendation of one or more candidate electronic signatures based on the ranking. The data processing system 102 can receive a selection of the electronic signature, and apply the electronic signature.

For example, FIG. 5B depicts an example GUI 540 provided by the data processing system 102 to select and apply e-signatures. The data processing system 102 can identify candidate electronic signatures that satisfy a constraint-value pair depicted in FIG. 5A, such as a value for a type of document, a value for a state, or a value for a tax type, for example. The data processing system 102 can identify the candidate e-signatures as 404, 408 and 410 because they are stored in the data repository of the data processing system and satisfy the one or more constraints of the electronic document being signed (e.g., 514, 530 536 or 538). The data processing system 102 can score each electronic signature using the constraint or attribute information for the electronic document, performance information associated with the electronic document, or performance information associated with the electronic signature 404, 408 or 410. The data processing system 102 generate a ranking 542 of the candidate electronic signatures 404, 408 and 410. For example, candidate electronic signature 404 can be the highest ranking electronic signature, the candidate electronic signature 408 can be the second highest ranking electronic signature, and the candidate electronic signature 410 can be the third highest ranking electronic signature. In some cases, the data processing system 102 may identify additional candidate electronic signatures, but only display a predetermined number (e.g., 3, 4, 5, or more) of top ranking electronic signatures.

The GUI 540 can include an interactive user interface element 544 to select a corresponding ranked electronic signature to apply to the electronic document. The GUI 540 can include a save button 548 to save the selection of the electronic signature. The GUI 540 can include a save button 546 to cancel the selection of the electronic signature without saving, and return to the GUI 500.

For example, FIG. 5C depicts an example GUI 550 of the sections for the electronic documents 514, 530, 536, and 538 from FIG. 5A after the data processing system 102 has applied electronic signatures via GUI 540. The GUI 550 can include a button 552 to view the completed forms. The completed forms can include the electronic signatures selected in GUI 540, for example.

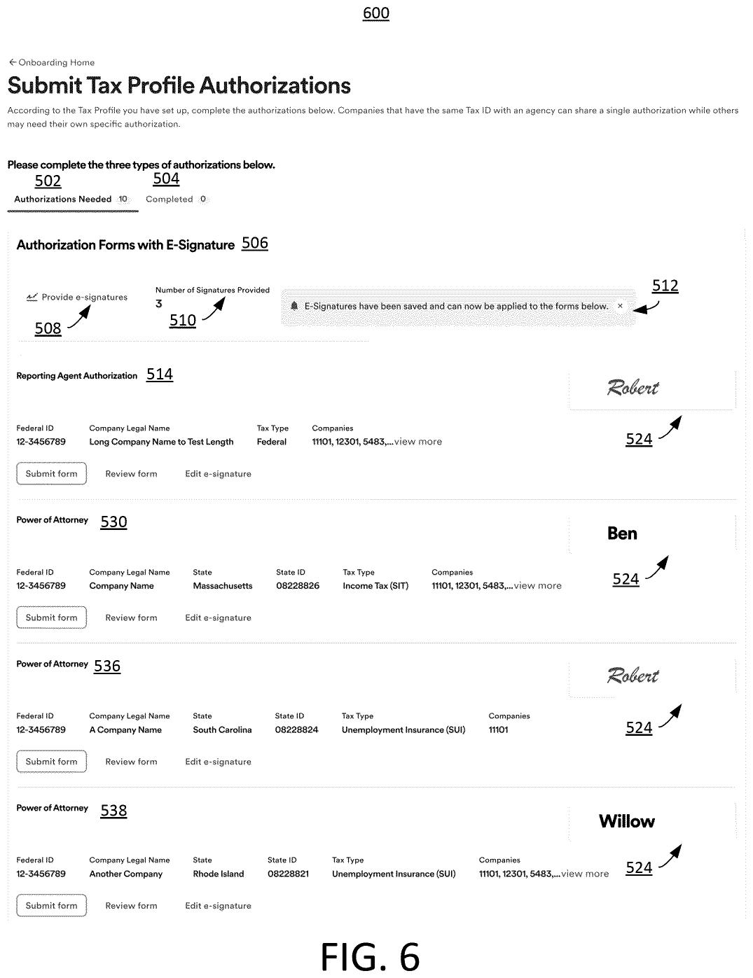

FIG. 6 is an illustrative example of a graphical user interface provided by a multiple electronic signature platform. The GUI 600 can be provided by one or more system or component depicted in FIG. 1, including, for example, a data processing system via an interface. The GUI 600 can be rendered or presented on a display device, such as a display device communicatively coupled with the data processing system or a client device. The GUI 600 can include one or more element, component or functionality depicted in the graphical user interfaces depicted in FIGS. 5A-5C. The GUI 600 can provide a display 524 of the e-signatures selected and applied to the electronic document via FIGS. 5A-5C.

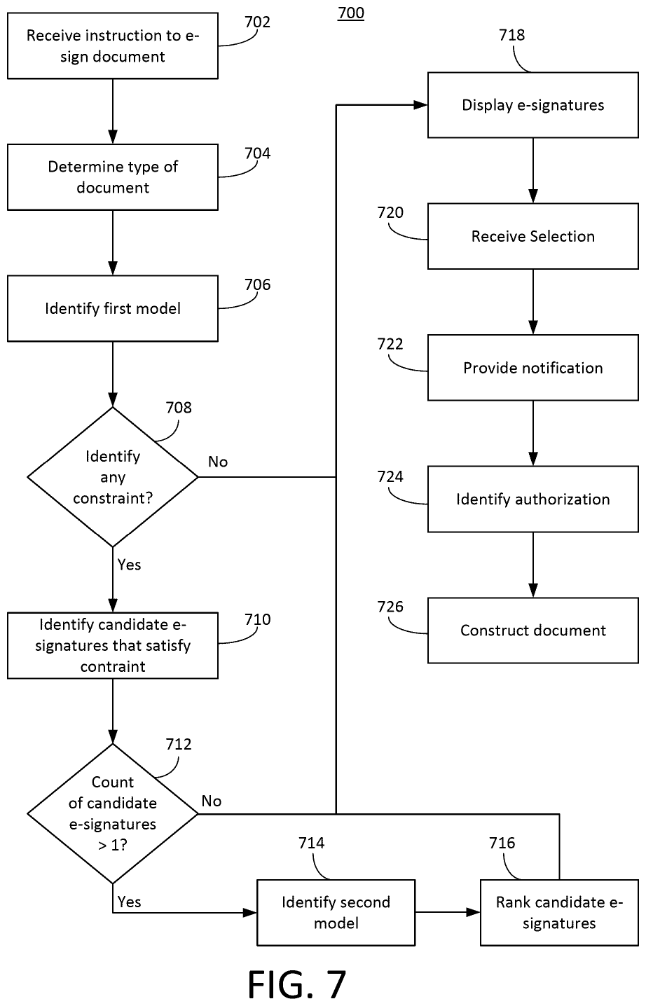

FIG. 7 is an illustrative example of a method of a multiple electronic signature platform. The method 700 can be performed by one or more system or component depicted in FIG. 1, including, for example, a data processing system. At ACT 702, the data processing system can receive an instruction to electronically sign an electronic document. The ACT 702 can include one or more process of ACT 202. At ACT 704, the data processing system can determine a type of the electronic document. The data processing system can determine the type of the document based on text in the document, a filename of the electronic document, parsing the electronic document, or otherwise processing the electronic document. The instruction receive at ACT 702 can indicate the type of the electronic document. The electronic document can include a type identifier from which the data processing system can determine the type of the electronic document. At ACT 706, the data processing system can select a first model. The data processing system can select the first model based on the type of the electronic document. The first model can be designed, constructed, or trained to identify a constraint in the electronic document. The data processing system can select the first model from multiple models based on the type of the electronic document. In some cases, the data processing system can include a model that is configured to identify constraints in multiple types of electronic document.

At decision block 708, the data processing system can use the first model from ACT 706 to identify any constraints in the electronic document. The data processing system can convert aspects of the electronic document into embeddings and input the embedding into the first model to generate an output that indicates a constraint. The first model can be a rule-based model or machine learning model. If the data processing system does not identify any constraints at decision block 708, the data processing system can proceed to ACT 718 and display electronic signatures that that have been saved for the entity associated with the electronic document or client device that provided the instruction at ACT 202.

If, however, the data processing system identifies a constraint at decision block 708, the data processing system can proceed to ACT 710 to filter the available signatures that are available for the entity in the data repository. The data processing system can identify the available e-signatures to identify candidate e-signatures that satisfy the constraint. For example, the constraint can be a geographic location, title, or authority level. If, at decision block 712, the data processing system determines that there is only 1 candidate electronic signature that satisfies the constraint, then the data processing system can proceed to ACT 718 to display the candidate electronic signature.

If, however, the data processing system determines at decision block 712 that there are more than 1 candidate e-signatures that satisfy the constraint, then the data processing system can proceed to ACT 714 to identify a second model that is designed, constructed or trained to rank the multiple candidate e-signatures. The second model can be a rule-based model or machine learning model. The second model can be based on or otherwise take into account historical performance associated with electronic signatures or electronic documents executed with electronic signatures. At ACT 716, the data processing system can score the candidate electronic signatures using the second model. The data processing system can score the candidate electronic signatures based on historical application of the candidate electronic signatures to the type of the electronic document or other attribute of the electronic document. The data processing system can rank the e-signatures based on the score.

At ACT 718, the data processing system can display the ranked electronic signatures. The data processing system can display the ranked e-signatures via a graphical user interface, such as GUI 540 depicted in FIG. 5B. At ACT 720, the data processing system can receive a selection of a candidate e-signature. The data processing system can receive the selection from a client device. The data processing system can receive the selection via the GUI 540, for example.

At ACT 722, the data processing system can provide a notification to the source of the selected candidate e-signature. The data processing system can transmit an e-mail, text message, prompt, instant message, or other type of notification. The notification can include a request for authorization or approval from the source of the e-signature. For example, the source of the e-signature (e.g., a signer) can be different from the client device that interacts with the data processing system to apply the electronic signature to the electronic document. The request can include information about the user applying the e-signature, the type of electronic document, the deadline for application of the e-signature, or other information associated with application of the e-signature. The request can include a

At ACT 724, the data processing system can identify the authorization to apply the e-signature. In some cases, the e-signature can be pre-authorized for application to the electronic document. In some cases, the authorization can be received from the source of the e-signature in response to the request for authorization provided at ACT 722. The authorization can provided via one or more techniques, such as a code, password, selection of a hyperlink, multi-factor authentication, or biometric authorization.

At ACT 726, the data processing system can construct the electronic document. The data processing system can construct the electronic document responsive to identification of the authorization of the e-signature. The data processing system can apply the authorized e-signature to construct the electronic document.

FIG. 8 illustrates a block diagram of a computing system 800 for implementing the embodiments of the technical solutions discussed herein, in accordance with various aspects. FIG. 8 illustrates a block diagram of an example computing system 800, which can also be referred to as the computer system 800. Computing system 800 can be used to implement elements of the systems and methods described and illustrated herein. Computing system 800 can be included in and run any device (e.g., a server, a computer, a cloud computing environment or a data processing system).

Computing system 800 can include at least one bus data bus 805 or other communication device, structure or component for communicating information or data. Computing system 800 can include at least one processor 810 or processing circuit coupled to the data bus 805 for executing instructions or processing data or information. Computing system 800 can include one or more processors 810 or processing circuits coupled to the data bus 805 for exchanging or processing data or information along with other computing systems 1000. Computing system 800 can include one or more main memories 815, such as a random access memory (RAM), dynamic RAM (DRAM), cache memory or other dynamic storage device, which can be coupled to the data bus 805 for storing information, data and instructions to be executed by the processor(s) 810. Main memory 815 can be used for storing information (e.g., data, computer code, commands or instructions) during execution of instructions by the processor(s) 810.

Computing system 800 can include one or more read only memories (ROMs) 820 or other static storage device 825 coupled to the bus 805 for storing static information and instructions for the processor(s) 810. Storage devices 825 can include any storage device, such as a solid state device, magnetic disk or optical disk, which can be coupled to the data bus 805 to persistently store information and instructions.

Computing system 800 may be coupled via the data bus 805 to one or more output devices 835, such as speakers or displays (e.g., liquid crystal display or active matrix display) for displaying or providing information to a user. Input devices 830, such as keyboards, touch screens or voice interfaces, can be coupled to the data bus 805 for communicating information and commands to the processor(s) 810. Input device 830 can include, for example, a touch screen display (e.g., output device 835). Input device 830 can include a cursor control, such as a mouse, a trackball, or cursor direction keys, for communicating direction information and command selections to the processor(s) 810 for controlling cursor movement on a display.

The processes, systems and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors 810 in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors coupled with memory, the one or more processors configured to:
determine, based on a first model, a constraint to electronically sign an electronic document associated with an entity;
identify a plurality of candidate electronic signatures linked with the entity that satisfy the constraint;
generate, based on a second model established for the entity, a ranking of the plurality of candidate electronic signatures that satisfy the constraint;
display, based on the ranking, one or more electronic signatures of the plurality of candidate electronic signatures; and
construct, responsive to a selection of an electronic signature of the one or more electronic signatures, a modified electronic document with the electronic signature.

2. The system of claim 1, wherein to determine the constraint based on the first model, the one or more processors are further configured to:
determine a type of the electronic document; and
select, based on the type of the electronic document, the first model from a plurality of models, wherein the first model is trained with machine learning on training data related to constraints to electronically sign the type of the electronic document.

3. The system of claim 1, wherein the constraint comprises at least one of a geographic region or an authorization level.

4. The system of claim 1, wherein to identify the plurality of candidate electronic signatures linked with the entity that satisfy the constraint, the one or more processors are further configured to:
access a data repository that stores profiles linked to a plurality of electronic signatures established by the entity; and
filter, based on the constraint, the profiles to identify the plurality of candidate electronic signatures.

5. The system of claim 1, wherein to determine the ranking based on the second model, the one or more processors are further configured to:
identify the second model trained with machine learning on training data related to historical performance of the plurality of candidate electronic signatures.

6. The system of claim 1, wherein to generate the ranking based on the second model, the one or more processors are further configured to:
identify profile data associated with the plurality of candidate electronic signatures; and
input the profile data into the second model to generate the ranking.

7. The system of claim 1, wherein the one or more processors are further configured to:
provide, responsive to construction of the modified electronic document, a notification to a source of the electronic signature.

8. The system of claim 1, wherein the one or more processors are further configured to:
receive, responsive to the display of the one or more electronic signatures based on the ranking, a selection of the electronic signature;
transmit a request for authorization to a source of the electronic signature; and
construct the modified electronic document with the electronic signature responsive to receipt of the authorization.

9. The system of claim 1, wherein the one or more processors are further configured to:
receive, responsive to the display of the one or more electronic signatures based on the ranking, a selection of a second electronic signature;
transmit, based on the selection, a request for authorization to a source of the second electronic signature;
receive a bounce message in response to the transmission; and
provide, for display responsive to the bounce message, an indication of the electronic signature of the plurality of candidate electronic signatures based on the ranking.

10. The system of claim 9, wherein the one or more processors are further configured to:
update, subsequent to the bounce message, a status of the second electronic signature to prevent the second electronic signature from inclusion in a subsequent plurality of candidate electronic signatures for the entity.

11. A method, comprising:
receiving, by one or more processors coupled with memory, from a device of an entity, an instruction to electronically sign an electronic document;
determining, by the one or more processors based on a first model, a constraint to electronically sign the electronic document;
identifying, by the one or more processors, a plurality of candidate electronic signatures linked with the entity that satisfy the constraint;
generating, by the one or more processors based on a second model established for the entity, a ranking of the plurality of candidate electronic signatures that satisfy the constraint;
providing, by the one or more processors based on the ranking, an indication of one or more electronic signatures of the plurality of candidate electronic signatures; and
constructing, by the one or more processors responsive to a selection of an electronic signature of the one or more electronic signatures, a modified electronic document with the electronic signature.

12. The method of claim 11, wherein determining the constraint based on the first model further comprises:
determining, by the one or more processors, a type of the electronic document; and
selecting, by the one or more processors, based on the type of the electronic document, the first model from a plurality of models, wherein the first model is trained with machine learning on training data related to constraints to electronically sign the type of the electronic document.

13. The method of claim 11, wherein the constraint comprises at least one of a geographic region or an authorization level.

14. The method of claim 11, wherein identifying the plurality of candidate electronic signatures linked with the entity that satisfy the constraint further comprises:
accessing, by the one or more processors, a data repository that stores profiles linked to a plurality of electronic signatures established by the entity; and
filtering, by the one or more processors based on the constraint, the profiles to identify the plurality of candidate electronic signatures.

15. The method of claim 11, wherein determining the ranking based on the second model further comprises:
identifying, by the one or more processors, the second model trained with machine learning on training data related to historical performance of the plurality of candidate electronic signatures.

16. The method of claim 11, wherein generating the ranking based on the second model further comprises:
identifying, by the one or more processors, profile data associated with the plurality of candidate electronic signatures; and
inputting, by the one or more processors, the profile data into the second model to generate the ranking.

17. The method of claim 11, comprising:
providing, by the one or more processors responsive to construction of the modified electronic document, a notification to a source of the electronic signature.

18. The method of claim 11, comprising:
receiving, by the one or more processors, responsive to the provision of the indication of the one or more electronic signatures based on the ranking, a selection of the electronic signature;
transmitting, by the one or more processors, a request for authorization to a source of the electronic signature; and
constructing, by the one or more processors, the modified electronic document with the electronic signature responsive to receipt of the authorization.

19. The method of claim 11, comprising:
receiving, by the one or more processors, responsive to the provision of the indication of the one or more electronic signatures based on the ranking, a selection of a second electronic signature;
transmitting, by the one or more processors based on the selection, a request for authorization to a source of the second electronic signature;
receiving, by the one or more processors, a bounce message in response to the transmission; and
providing, by the one or more processors for display responsive to the bounce message, an indication of the electronic signature of the plurality of candidate electronic signatures based on the ranking.

20. A non-transitory computer-readable medium that stores processor-executable instructions, wherein execution of the processor-executable instructions by one or more processors cause the one or more processors to:
determine, based on a first model, a constraint to electronically sign an electronic document associated with an entity;
identify a plurality of candidate electronic signatures linked with the entity that satisfy the constraint;
generate, based on a second model established for the entity, a ranking of the plurality of candidate electronic signatures that satisfy the constraint;
display, based on the ranking, one or more electronic signatures of the plurality of candidate electronic signatures; and
construct, responsive to a selection of an electronic signature of the one or more electronic signatures, a modified electronic document with the electronic signature.
